(19) United States
(12) Patent Application Publication
(10) Pub. No.: US 2023/0196295 A1
(43) Pub. Date: Jun. 22, 2023

(54) SYSTEMS AND METHODS FOR AUTOMATICALLY INDEXING USER DATA FOR UNKNOWN USERS

(71) Applicant: Skill Survey, Inc., Wayne, PA (US)

(72) Inventors: Ray A. Bixler, Downingtown, PA (US); Erich Baumbach, Philadelphia, PA (US); Darica Ward, Lambertville, NJ (US); Peter Constantinidis, Downingtown, PA (US); Cynthia Hedricks, Princeton, NJ (US); Chin-Hock Low, Bryn Mawr, PA (US)

(21) Appl. No.: 17/963,892

(22) Filed: Oct. 11, 2022

Related U.S. Application Data
(63) Continuation of application No. 17/096,745, filed on Nov. 12, 2020, now abandoned.
Application No. 17/096,745 is a continuation of application No. 16/110,151, filed on Aug. 23, 2018, now abandoned.
Application No. 16/110,151 is a continuation of application No. 13/826,125, filed on Mar. 14, 2013, now abandoned.
(60) Provisional application No. 61/653,156, filed on May 30, 2012.

(51) Int. Cl. G06Q 10/1053

(52) U.S. Cl. CPC G06Q 10/1053

(57) ABSTRACT

Systems and methods for recruiting candidates for employment opportunities are disclosed. Systems and methods to create a talent pool of job candidates and identify the candidates within that pool who are potentially best qualified and be inclined to consider current job openings that has been matched to their aspirations for a career move. In particular, passive candidates, persons who are not actively looking for work, are targeted and monitored for indications that they may be interested in considering potential employment opportunities. Passive candidates are obtained from various sources, for example, a prehire or reference checking service.

### RELATED APPLICATIONS

This application is a continuation of U.S. patent application Ser. No. 17/096,745 filed Nov. 12, 2020, which is a continuation of U.S. patent application Ser. No. 16/110,151 filed Aug. 23, 2018, which is a continuation of U.S. patent application Ser. No. 13/826,125 filed Mar. 14, 2013, which claims the benefit of and priority to U.S. Provisional Application Ser. No. 61/653,156 filed May 30, 2012, the teachings of which are incorporated herein by reference in their entirety.

### FIELD

At least some embodiments disclosed herein relate, in general, to systems and methods for recruiting candidates for employment opportunities, and more particularly, to recruiting systems and methods that target candidates exhibiting behavior that indicates increasing interest in new employment.

### BACKGROUND

Employers typically track, evaluate and recruit candidates for open positions on an ongoing basis. Candidates for open positions may be identified from various sources such as, for example, job boards, resumes received via email or mail, job fairs and references of job applicants. Recruiters with employers focus on candidates that are qualified for open positions, appear to be motivated to consider new employment, and have various indicia of quality and reliability such as, for example, current employment and a good track record of employment.

### SUMMARY

Systems and methods for recruiting candidates for employment opportunities are disclosed herein. More particularly such recruiting systems and methods enable employers, or the recruiters for such employers, to make contact with, track, and interact with potential candidates and also to detect when passive candidates become potential candidates.

According to aspects of the presently disclosed embodiments illustrated herein, there is provided a method for recruiting candidates for employment opportunities that is performed in a number of respects using a computer or computing device. Such a method includes providing to a candidate, an invitation to join an employer network including one or more employers and receiving from the candidate, an acceptance of the invitation. Such a method also includes, in response to receiving an acceptance of the invitation, requesting from the candidate, candidate related information. Such providing, receiving and requesting being done using a computing device.

Such a method also includes receiving from the candidate, the candidate related information and in response to receiving the candidate related information, determining using the candidate related information, a first temperature of the candidate. The first temperature of the candidate being a metric indicating the candidate's potential willingness to consider employment with the employer. In further embodiments, such a metric further indicates the cultural fit of the candidate to the employer. Such receiving and determining also being done using a computing device.

Such a method also includes receiving from the candidate, an update to the candidate related information and in response to receiving the update to the candidate related information, determining-using the update to the candidate related information, a second temperature of the candidate. Also such a method includes determining that the second temperature is greater than the first temperature; and in response to determining that the second temperature is greater than the first temperature, notifying the employer that the second temperature is greater than the first temperature. Such receiving, determining and notifying being done using a computing device.

According to aspects illustrated herein, there is provided a machine readable media storing instructions that, when executed by a data processing system, cause the data processing system to perform a method. Such a method includes providing, to a candidate, an invitation to join an employer network of one or more employers and receiving, from the candidate, an acceptance of the invitation. In response to receiving an acceptance of the invitation, requesting, from the candidate, candidate related information and receiving, from the candidate, the candidate related information and in response to receiving the candidate related information, determining, using the candidate related information, a first temperature of the candidate, the first temperature of the candidate comprising a metric indicating the candidate's potential willingness to consider employment with the employer. In further embodiments, such a metric further indicates the cultural fit of the candidate to the employer.

Such a method includes receiving, from the candidate, an update to the candidate related information and in response to receiving the update to the candidate related information, determining, using the update to the candidate related information, a second temperature of the candidate. Also, such a method includes determining that the second temperature is greater than the first temperature and in response to determining that the second temperature is greater than the first temperature, notifying the employer that the second temperature is greater than the first temperature.

According to aspects illustrated herein, there is provided a computer system including a memory and at least one processor coupled to the memory to provide, to a candidate, an invitation to join an employer network of an employer; receive, from the candidate, an acceptance of the invitation and in response to receiving an acceptance of the invitation, a request, from the candidate, candidate related information. In addition such a system includes, receiving, from the candidate, the candidate related information and in response to receiving the candidate related information, determining, using the candidate related information, a first temperature of the candidate, the first temperature of the candidate comprising a metric indicating the candidate's potential willingness to consider employment with the employer. In further embodiments, such a metric further indicates the cultural fit of the candidate to the employer.

Such a computer system also provides receiving, from the candidate, an update to the candidate related information; in response to receiving the update to the candidate related information, determining, using the update to the candidate related information, a second temperature of the candidate; determining that the second temperature is greater than the first temperature; and in response to determining that the second temperature is greater than the first temperature, notifying the employer that the second temperature is greater than the first temperature.

Other aspects and embodiments are discussed below.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 is a high-level schematic view of an embodiment of a system for recruiting candidates for employment opportunities.

FIG. 2 is a schematic diagram of an embodiment of a website provided by a system for recruiting candidates for employment opportunities.

FIG. 3 illustrates the types of user profiles that are created and maintained by an embodiment of a system for recruiting candidates for employment opportunities.

FIG. 4 illustrates an embodiment of a process to invite a potential candidate to become a member of a system for recruiting candidates for employment opportunities.

FIG. 5 illustrates an embodiment of an invitation to a potential candidate to become a member of a system for recruiting candidates for employment opportunities

FIG. 6 shows an embodiment how an invitation to become a member of a system for recruiting candidates for employment opportunities can be embedded in webpages that are potential sources of candidates.

FIG. 7A illustrates an embodiment of a user interface that enables candidates to login to a system for recruiting candidates for employment opportunities.

FIG. 7B illustrates an embodiment of a user interface that enables candidates to register with a system for recruiting candidates for employment opportunities.

FIG. 8A, FIG. 8B and FIG. 8C illustrate an embodiment of a user interface that enables candidates to complete a short survey describing their current situation to a system for recruiting candidates for employment opportunities.

FIG. 9A, FIG. 9B and FIG. 9C illustrates an embodiment of a user interface that provides a home page for a member (candidate) of a system for recruiting candidates for employment opportunities.

FIG. 10 shows an embodiment of a method to calculate a candidate's temperature (i.e., their inclination to consider a new opportunity).

FIG. 11A and FIG. 11B illustrate an embodiment of a user interface that provides a workbench for a recruiter using a system for recruiting candidates for employment opportunities.

FIG. 12A and FIG. 12B illustrates an embodiment of a user interface that allows a recruiter to view a profile of a member (candidate) of a system for recruiting candidates for employment opportunities.

FIG. 13 illustrates a process embodying various triggers to prompt candidates to update their current situation, and the system will alert the recruiters to any changes on the candidate's situation, with a system for recruiting candidates for employment opportunities.

FIG. 14 shows a block diagram of an embodiment of a data processing system that can be used in various embodiments of the disclosed systems and methods.

FIG. 15 shows a block diagram of an embodiment of a user device that can be used in various embodiments of the disclosed systems and methods.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description and drawings are illustrative and are not to be construed as limiting. Numerous specific details are described to provide a thorough understanding of the presently disclosed embodiments. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

For the purposes of this disclosure, the term “server” should be understood to refer to a service point that provides processing, database, and communication facilities. By way of example, and not limitation, the term “server” can refer, in some embodiments, to a single, physical processor with associated communications and data storage and database facilities, or it can refer to a networked or clustered complex of processors and associated network and storage devices, as well as operating software and one or more database systems and applications software which support the services provided by the server. In other embodiments, the term “server” can refer to one or more virtual servers hosted on one or more physical servers or provided by cloud-based services. In yet other embodiments, term “server” may refer to any type of hardware and/or network configuration now known, or later to be developed, that provides processing, database, and communication facilities.

The drawing figures including flow charts and process figures, as well as the discussion of the methods embodied in the presently disclosed embodiments, herein illustrate the structure of the logic embodied in computer program software for execution on a computer, computing device, digital processor, application specific integrated circuit (ASIC) or microprocessor. Those skilled in the art will appreciate that the drawing figures and the method description illustrate the structures of the computer program code elements, including logic circuits on an integrated circuit, that function according to the presently disclosed embodiments. As such, the presently disclosed embodiments also are practiced in its essential embodiment(s) by a machine component that renders the program code elements in a form that instructs a digital processing apparatus (e.g., computer) to perform a sequence of function step(s) corresponding to those shown in the drawings and/or described in the description. Such program elements include but are not limited to code segments, instructions and criteria.

In at least some embodiments, presently disclosed embodiments are directed to systems and methods to create a talent pool of j ob candidates and identify the candidates within that pool who are potentially best qualified and be inclined to consider current job openings that has been matched to their aspirations for a career move. In further embodiments such methods and systems also can identify candidate(s) within the pool who also would appear to have a proper fit to the culture of the employer (i.e., proper cultural fit). In an embodiment, candidates for employment can be classified as, inter alia, passive, active and potential.

In an embodiment, a passive candidate is someone who is not actively looking for work. They are typically currently employed, do not post their resume to be found by recruiters searching for candidates; and might not even have an updated professional social networking profile, for example, on LINKEDIN because they don't feel they need one. Passive candidates are perceived by recruiters to be highly valuable candidates because they are currently employed and thus, they are most likely very good, talented people. Recruiters also know that even if someone is currently employed, they might be open to hearing about new opportunities that are especially better to fulfill important career or work aspirations for those candidates, thus the term passive candidate. Such a candidate is deemed to be because the Recruiters have to initiate the contact with the candidate when they feel they have a job opening that would be of interest to such a candidate.

Often times, recruiters want to get the attention of these passive candidates to begin building relationships with them so they might entice the passive candidate to come work for them at some point in the future when the candidates' situation might change over time or when a new position opens that meets their aspirations. Building relationships with passive candidates is becoming more important in order to build a pipeline of candidates as jobs like engineers, programming, physical therapy and others are very difficult to fill because talent is hard to find; and are professions with growing demand.

One excellent source of passive candidates is a reference checking or prehire information gathering service. In various embodiments, a reference checking service can be described as a third-party system used by employers to check references for persons that are being considered for employment by the employer. For example, the reference checking service could send an email to a reference for a potential hire requesting that the reference fill out a questionnaire relating to the potential hire. If the reference fills out the questionnaire, the reference can be invited to become a potential candidate.

References of potential hires are often perceived to be one of the most valued sources of new talent because the step of checking references is usually done at the very end of a hiring process on job candidates who have already been interviewed and screened. These job applicants are most likely going to be hired, and all that is left to do is complete a reference check. Therefore, if the job applicant is most likely going to be hired, it indicates the employer perceives the applicant to be a desirable employee, and the applicant's references have a high probability of being desirable employees also. In various other embodiments, passive candidates can be recruited from, for example, industry directories, industry publications, industry conference attendees and public documents such as patents and published patent applications.

In an embodiment, an active candidate is someone who is actively looking for work. They might be unemployed, or they might be currently working yet not happy at their current job, so they feel ready to start looking at new opportunities. Therefore, people who fall into this category are actively looking for one reason or another and are very amenable to discussing an appropriate opportunity. If an active candidate is unemployed, they typically post their resumes on job boards, make calls to recruiters, and do whatever they can to get a job. While potentially unfair and biased, the unemployed active candidate is the least valued candidate because recruiters tend to assume there is a reason they are unemployed, i.e. they probably were not that good of a worker at their last job, and otherwise they would still be working.

Active candidates that are currently employed may not post their resumes on public job boards because they're still employed and they don't want their employment search to be made public. They may update their professional social networking profile (e.g., LINKEDIN profile) and/or directly reach out to third-party recruiters, especially those they have worked with previously, to find new work confidentially. Today it is difficult for such candidate to get the attention of corporate recruiters. These “currently employed active candidates” are valued higher than “unemployed active candidates,” yet still not as highly as the passive candidate unless the reason they are looking for new work is plausible.

In an embodiment, potential candidates are passive candidates that, given the right opportunity or, after some time has passed, may feel more inclined to entertain new opportunities. In an embodiment, a continuum of candidate psychology could be stated as:
PASSIVE (not considering/looking)-+
POTENTIAL (Will listen)
ACTIVE (would like to consider any/all opportunities)

In various embodiments, presently disclosed embodiments are directed to recruiting systems and methods that enable employers to make contact with, track, and interact with passive candidates and detect when such candidates become potential candidates. It should be understood, however, that the systems and methods disclosed herein can be used to track and interact with active candidates as well, as will be readily apparent to those skilled in the art from the following disclosure.

In various embodiments, presently disclosed embodiments are directed to systems and methods that correlate, inter alia, candidates' current situation and career aspirations, as well as candidates' history of past hires to calculate an aggregate “temperature” of such candidates. Also, such systems and methods can correlate the cultural fit of the candidate(s) and calculate an aggregate “temperature” of such a candidate(s). In an embodiment, a candidate's temperature is a metric that reflects the likelihood that the candidate will consider new employment opportunities. Among other things, a change in a candidate's temperature may indicate a passive candidate is becoming, or will soon become, a potential candidate, and thus, should be contacted by a recruiter from a prospective employer before the candidate enters the open job market (i.e., becomes an active candidate).

In various embodiments, presently disclosed embodiments are directed to systems and methods to enable multiple recruiters of an employer to collaboratively rate candidates' qualifications. Combined with, inter alia, temperature metrics for a candidate, the systems and methods described herein, allow a recruiter to focus and manage candidates of qualified candidates with highest temperature for current openings.

In various embodiments, presently disclosed embodiments are directed to systems and methods that help recruiters manage qualified candidates that currently have low temperature to continuously monitor the candidates change in temperature to become potential candidate (a candidate that has become amenable to suitable opportunities)—serving as a pipeline for future openings. In various embodiments, the systems and methods disclosed herein are particularly well-suited for recruiting passive candidates and developing such candidates into active candidates, as will be readily apparent to those skilled in the art from the disclosure below.

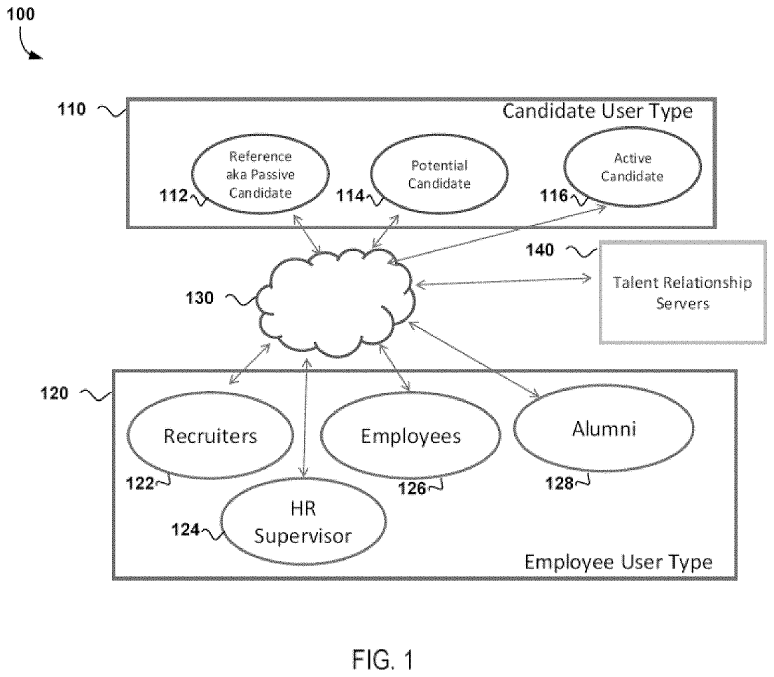

FIG. 1 is a high-level schematic view of an embodiment of a system 100 for recruiting candidates for employment opportunities.

In an embodiment, various candidate types 110 such as passive candidates 112, potential candidates 114, and active candidates 116 access services provided by the system 100 for recruiting candidates hosted on one or more talent relationship servers 140 over a network 130. Such a network 130 can be, for example, a WAN, LAN, the Internet or a combination thereof. In an embodiment, the candidates 110 are invited to become members of the system 100 for recruiting candidates. In an embodiment, candidates 110 are invited to become members of the system by, without limitation, various employees 126 of an employer 120, including, without limitation, recruiters 122, HR supervisor 124, or alumni 128 (ex-employees of the employer) and/or third-party services acting on behalf of an employer, such as a prehire or reference checking service. In an embodiment, candidates 110 are invited to become members of the system by other candidates. As described herein, in an embodiment, a candidate cannot elect to become a member without an invitation. In some embodiments, the systems and methods can be configured and arranged so as to allow a candidate to become a member without an invitation under predetermined conditions.

In some embodiments, when a candidate(s) become members of the system 100, the system collects various information regarding each candidate 110, such as for example, the candidate's sentiments regarding their current jobs and aspirations they would seek in their next career opportunity. In an embodiment, the system and method are configured so as to use a series of questions and/or rankings so that an assessment can be made to determine a candidate's preferred cultural qualities in an employer.

In some embodiments, the system 100 uses such information to calculate a “temperature” metric that attempts to assess each candidate's inclination to consider a specific open position based on, for example, matching each candidate's sentiment/aspiration, jobs specifications and/or company cultural characteristics.

In some embodiments, the system 100 can support multiple employers. In an embodiment, invitations are specific to a particular employer, and when a candidate accept such an invitation, such candidate's data and/or information is only visible to the employer whose invitation they accept. In an embodiment, candidates can elect to make their information visible to other employers known to the system on a company-by-company basis. In an embodiment, the system advertises other employers to candidates, for example, via emails that shows other employers that might have jobs that suits the candidates' experience and skills and/or a list shown to the candidates on their respective home pages when they log into the system, but only reveals candidate's information to such other employers with the candidate's consent. In an embodiment, the system 100 may choose to delay (by a configurable period of time e.g., 30 days) advertising or showing other employers on the system to a new candidate that is joining their first employer network in the system. In an embodiment, when a candidate joins the network, the system will also inform recruiters of one or more companies or employers. In further embodiments, the system will inform employees and alumni of the employer that the candidate might already be connected to on a social network site (as known in the art or hereinafter developed) such as for example, LINKEDIN or FACEBOOK.

In some embodiments, various employer personnel of an employer 120 such as recruiters 122, other HR personnel 124, employees 126 and alumni 128 also are able to access services provided by the system 100 for recruiting a candidate. Among other things, the system enables recruiters 122 to view the current candidates 110 and information relating to such candidates, including, inter alia, the candidates' sentiments relating to their current jobs, their aspirations, their employment history, their rating and their temperature. In an embodiment, the system provides various mechanisms for teams of recruiters to manage one or more pools of candidates in a coordinated & collaborative manner. In an embodiment, the system provides facilities that enable candidates to interact with the recruiters 122 and the employees 126 of an employer. In an embodiment, the candidates are able to connect to employees of an employer, view their profile and exchange emails with them, for example, about working for the employers. The presumption is that one of the best recruiting tools is employees who are happy at their job.

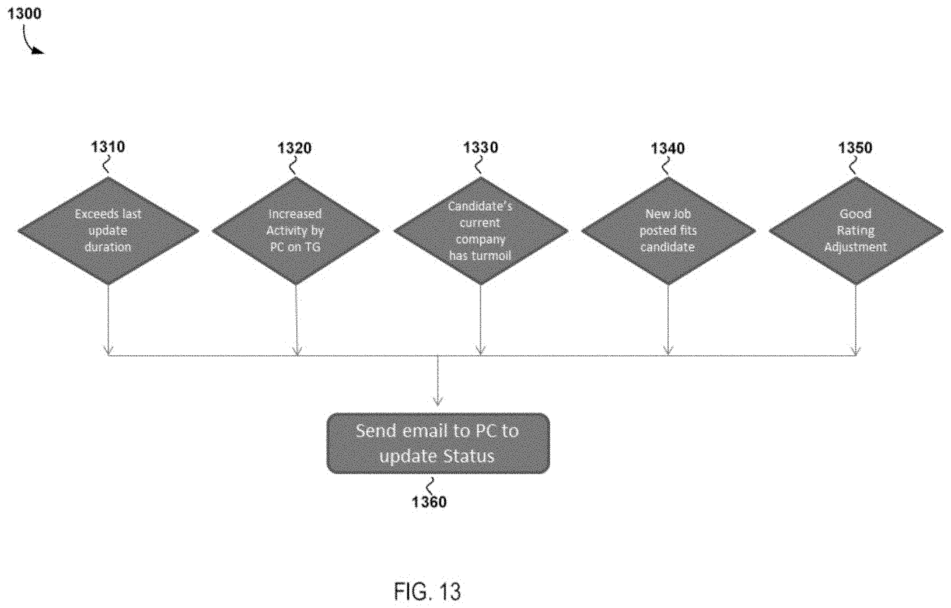

In an embodiment, the system provides various means to continuously measure candidates' current job situation and to prompt recruiters 122 to pursue such candidates when their temperature rises or when a new job opening occurs that is suited to a candidate's credentials and preferences. As described herein in connection with FIG. 13, in an embodiment, the system 100 periodically prompts candidates to update their profile, responsive to various triggers.

In an embodiment, the system 100 for recruiting candidates is hosted on one or more talent relationship servers 140 that are maintained and/or controlled by one or more third parties. It also should be understood that the term “talent relationship servers” refers to any type of server that implements one or more components of the systems and methods disclosed herein. In an embodiment, the system for recruiting candidates is provided to employers as Software as a Service (SaaS), and the employer is charged for use of the service, for example, on a flat fee basis, on a per seat basis, on a per transaction basis and/or on a per hire basis. In an embodiment, the system 100 is hosted on one or more talent relationship servers 140 that are maintained and/or controlled by an employer.

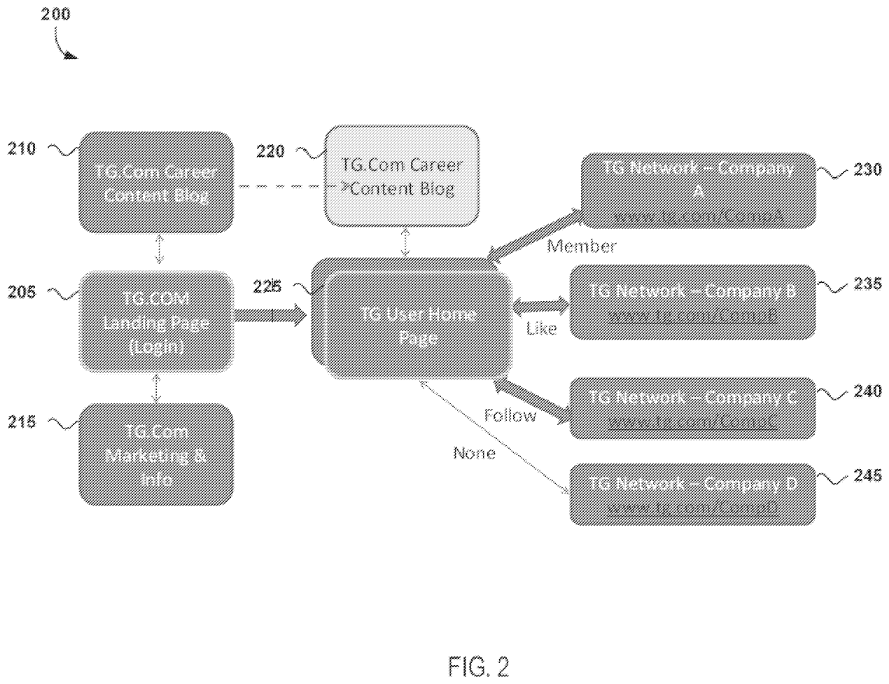

Referring now to FIG. 2 there is shown a schematic diagram of an embodiment of a website 200 provided by a system for recruiting candidates for employment opportunities.

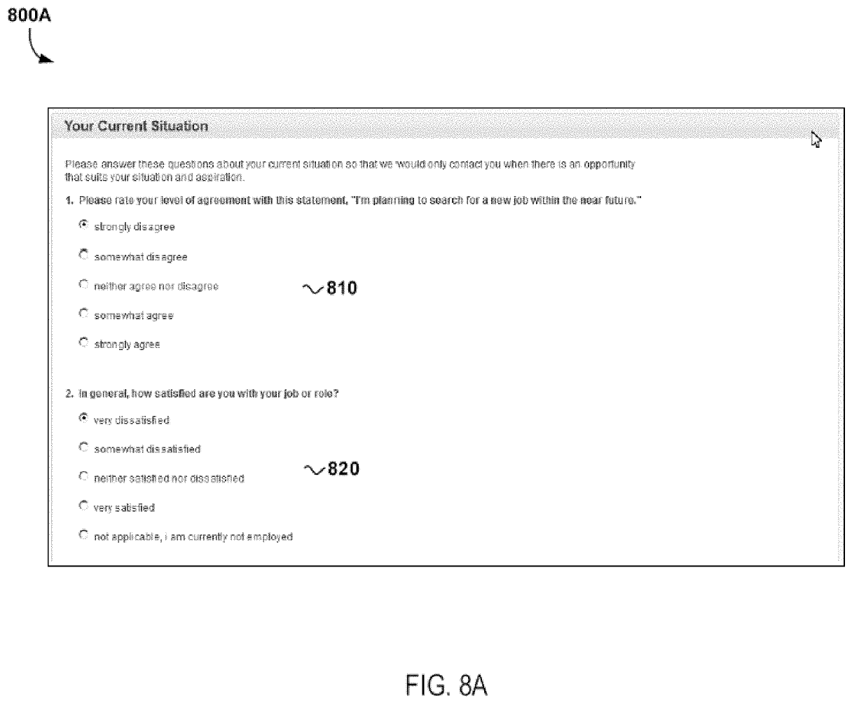

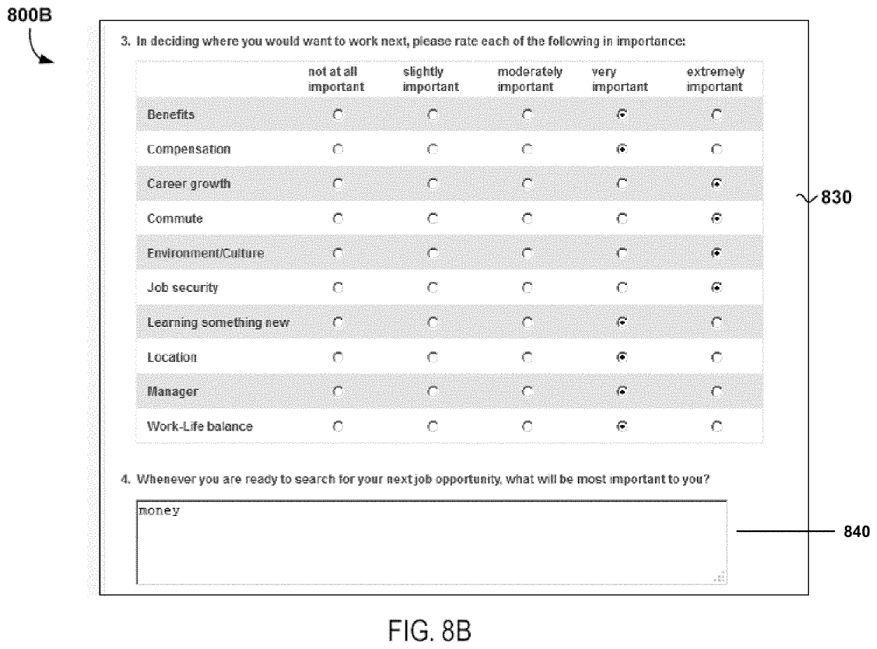

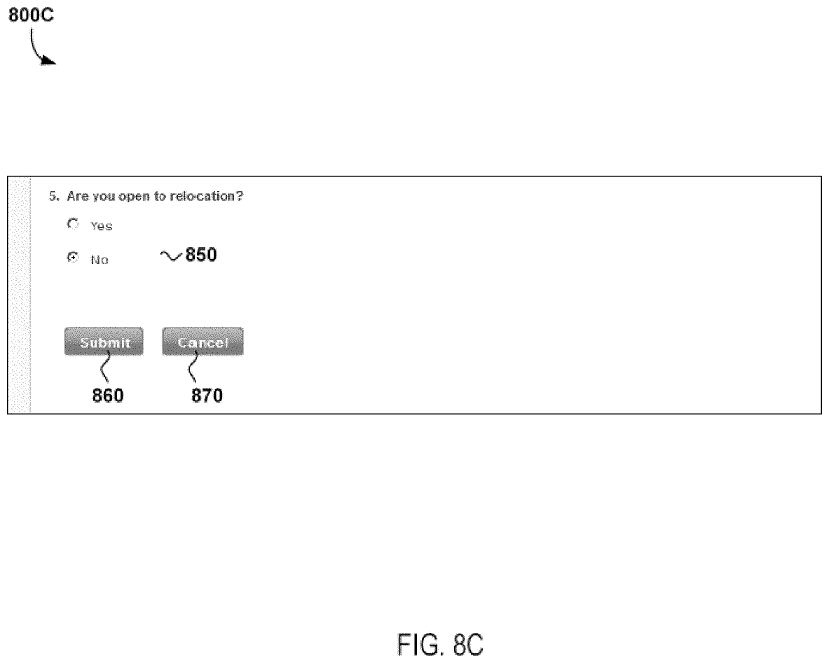

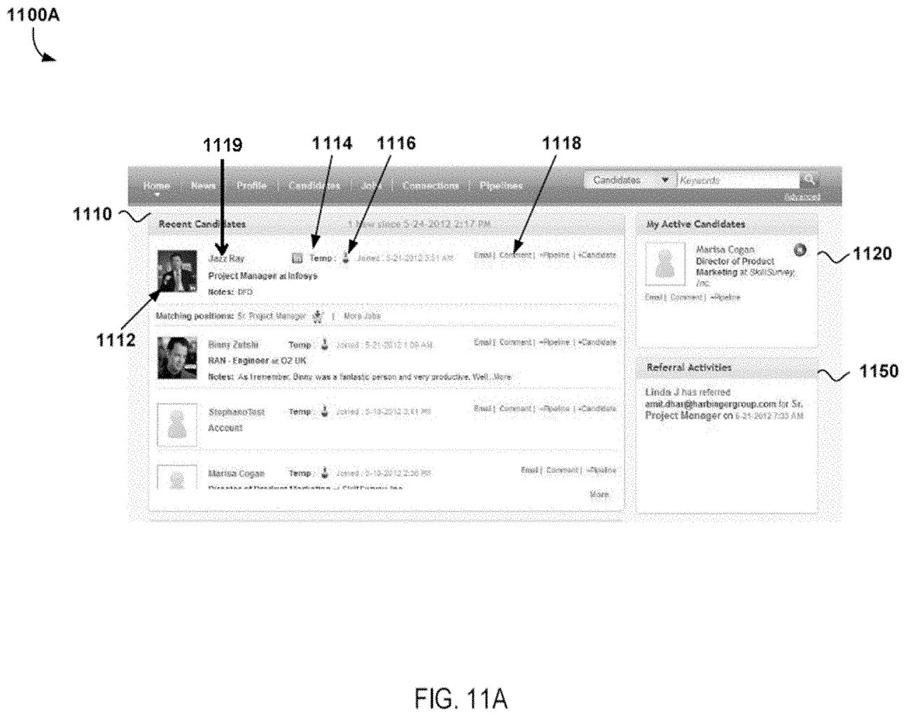

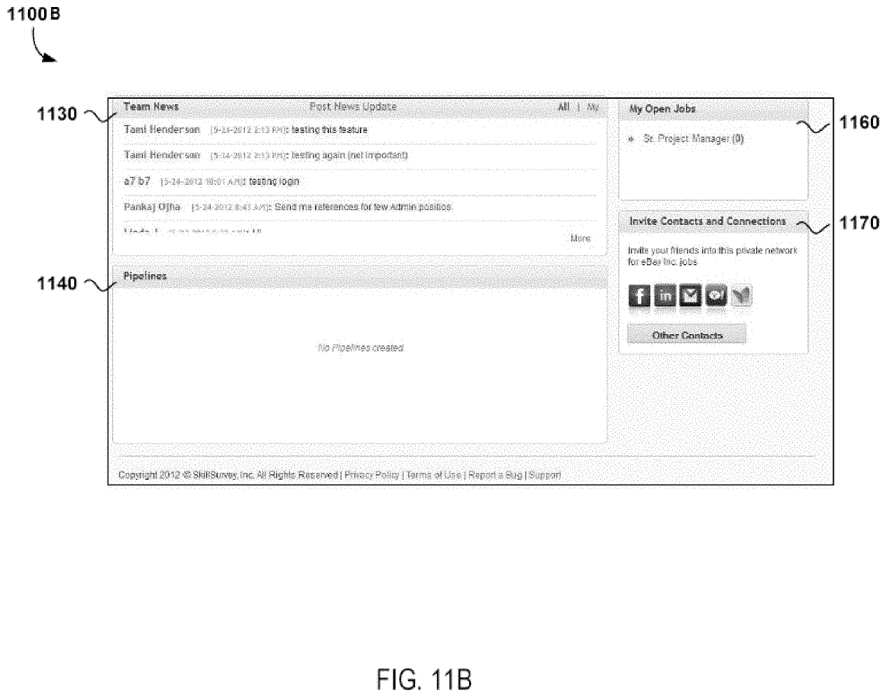

In the embodiment illustrated in FIG. 2, the domain name “TG.Com” and/or “www.tg.com” should be understood to refer a domain name directed to one or more talent relationship servers hosting a system for recruiting candidates such as those described herein. It should be understood that the website structure shown in FIG. 2 is purely exemplary or illustrative, and does not include all webpages that are present in various embodiments of the disclosed systems and methods such as, for example, webpages used by recruiters (see, e.g., FIG. 11A and FIG. 11B) or webpages used to collect data from candidates (see, e.g., FIG. 8A, FIG. 8B and FIG. 8C). It should be further understood that the domain name “TG.com” is purely illustrative and that any domain name could be used.

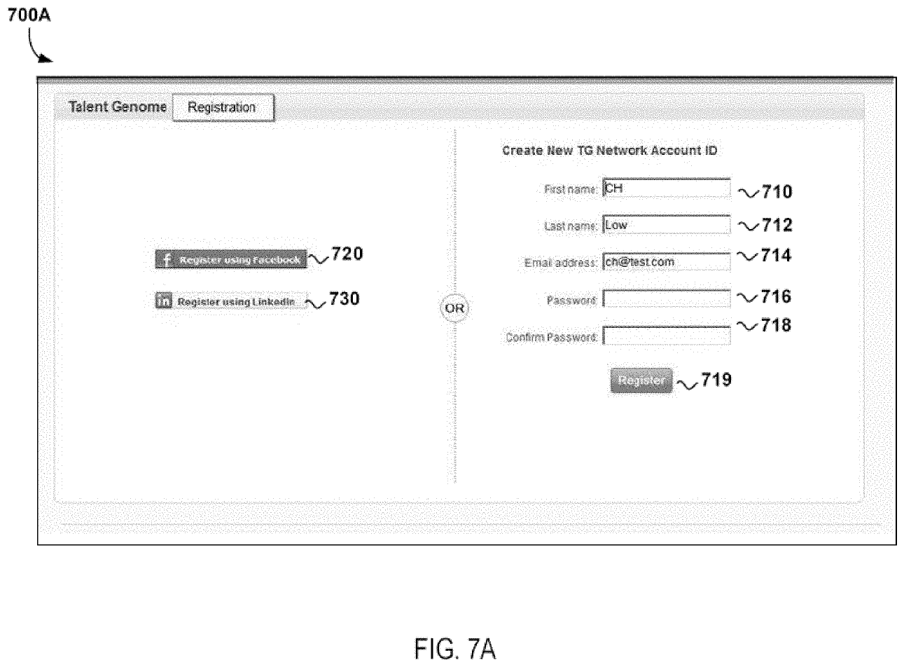

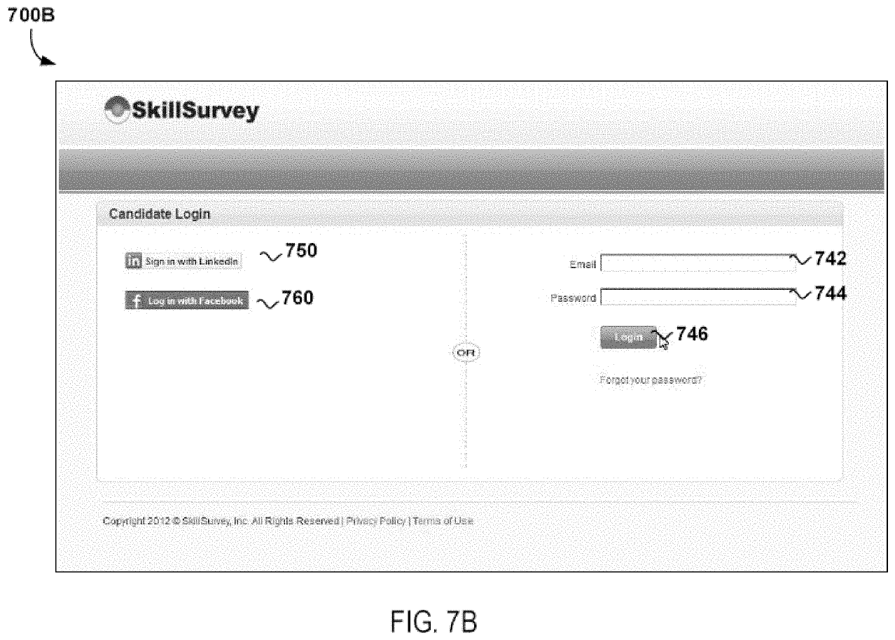

In the embodiment illustrated in FIG. 2, the presently disclosed system 100 is hosted and maintained by a recruiting system service provider and supports at least four employers, companies A, B, C and D. In an embodiment, the website 200 also provides a number of webpages 205, 210 and 215 that are publicly accessible. In an embodiment, the website 200 provides a landing page 205 that enables members of the system, whether candidates or employer personnel, to login to the system (see, FIG. 7A and FIG. 7B below). In an embodiment, the website 200 further provides career content BLOG 210. In an embodiment, the website 200 further provides a webpage 215 providing marketing information relating to the system for recruiting candidates and/or the recruiting system service provider. In further embodiments, the marketing webpage can provide information about the products and services being offered by the company hosting the site. In addition it also can provide information about the science and the validity studies behind the products.

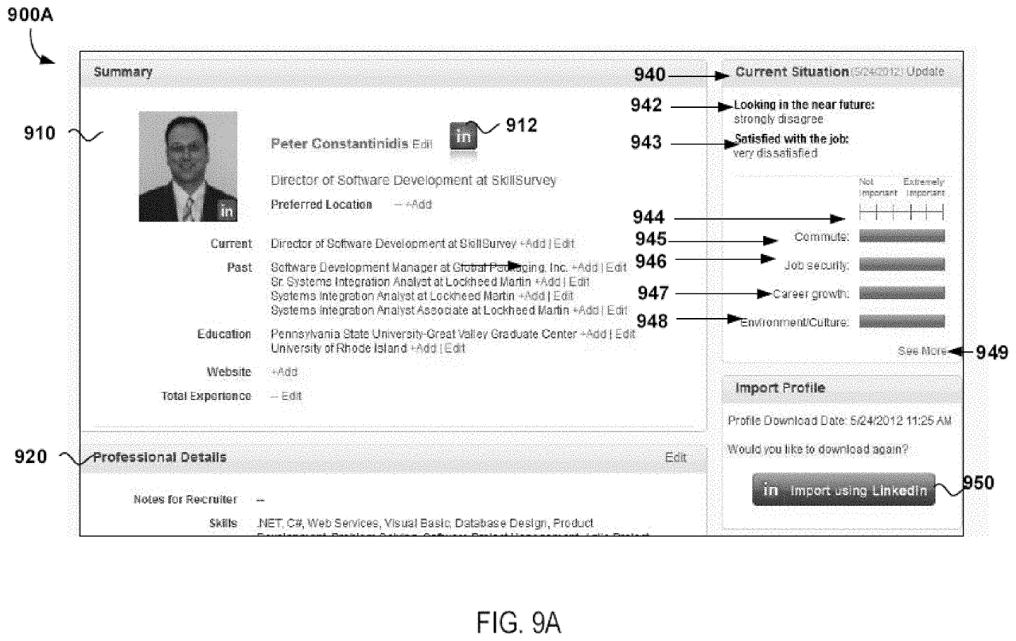

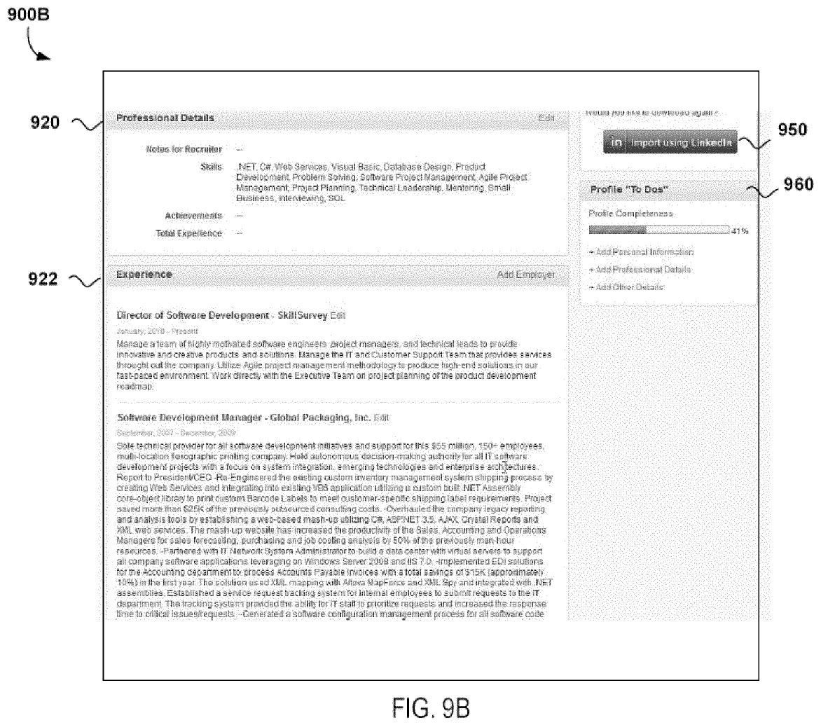

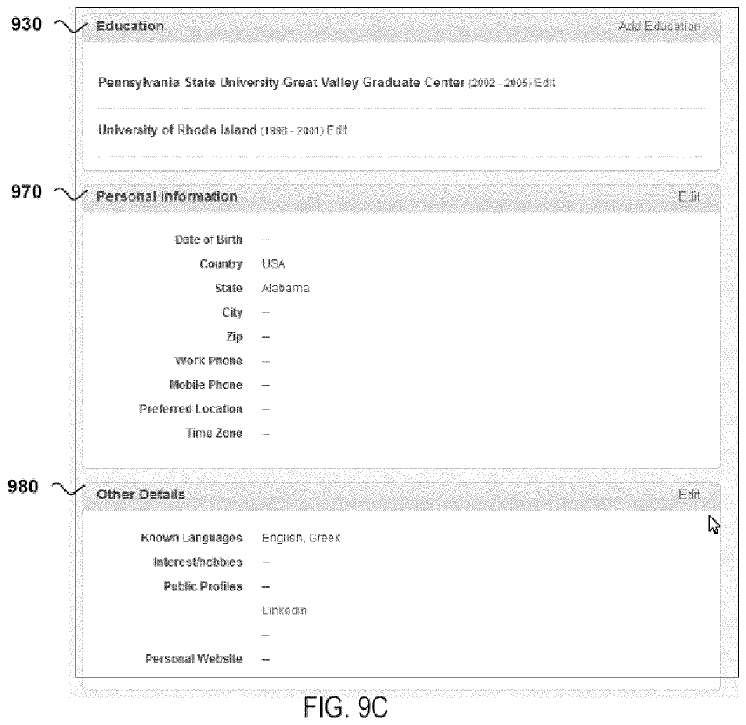

In an embodiment, when a candidate logs into the system via the landing page 205, the candidate is directed to a user home page 225 for the candidate. In an embodiment, the candidate's user home page 225 displays the candidate's profile. In an embodiment, the candidate's user home page 225 displays the candidate's connections to one or more employers 230, 235, 240 and 245. In an embodiment, the user home page 225 also is configurable so as to display a career content BLOG 220 on the user home page. In an embodiment, the user home page 225 is similar to that shown in FIG. 9A, FIG. 9B and FIG. 9C and described in greater detail below.

In an embodiment, when a candidate accepts an invitation of a specific employer, not only does the candidate become a member of the system as a whole, but also becomes a member of the employer's network within the system. In the embodiment illustrated in FIG. 2, the candidate is a member of company A's network 230. As a member of company A's network 230, the candidate's information, such as profile information and temperature, is visible to recruiters within company A In an embodiment, the candidate can access company A's network page “www.tg.com/CompA” 230, which can provide various types of information about company A such as, for example, current job openings and company news. In an embodiment, as a member of company A's network, the candidate can additionally receive updates from Company A such as, for example, new job postings, update of HR news, company news or new open positions. Such information may be provided to candidates to keep the candidates abreast of the employer's business, in case a new job might appeal to the candidate and/or if the candidate can refer somebody they know to an open job position. In an embodiment, updates can be provided by email to the candidate. In an embodiment, a candidate can additionally or alternatively also view the same news feed on the employer's network landing page.

In an embodiment, candidates can also interact with other employers that are known to the system. In the embodiment illustrated in FIG. 2, the candidate has elected to “follow” company C 240. In an embodiment, the user's home page 225 provides facilities for candidates to browse all employers that have created a network on the system and select which employers to like or follow. In an embodiment, when a candidate elects to follow an employer, the candidate receives updates, such as new job postings, from the employer, but does not want the company to contact them, nor do they wish their information to be visible to the employer. In an embodiment, if a candidate follows an employer, the candidate can access the employer's network page. In the illustrated embodiment, the candidate can access company C's network page “www.tg.com/CompC” 240, which can provide various types of information about company C such as, for example, current job openings and company news. In an embodiment, as a follower of company C, the candidate can additionally receive updates from Company C.

In the embodiment illustrated in FIG. 2, the candidate also has elected to “like” company B 235. In an embodiment, when a candidate elects to like an employer, it means that the candidate really likes the company and would love to join the company's network 235 on the system. In an embodiment, when a candidate likes an employer, the candidate expresses an interest to explore employment at that company, the candidate's information becomes visible to the employer and recruiters are notified that the candidate has implicitly requested to join the employer's network. In an embodiment, recruiters can then evaluate the candidate and, at their discretion, invite the candidate to become a member of the employer's network or ignore the candidate's implied request.

In an embodiment, candidates, even if a member of the system (e.g., a member of at least one employer's network) cannot elect to become a member of a particular employer's network without an invitation. One of the values of such a feature for the system, is to limit the number of candidates considered by an employer, namely, only to those candidates with potential, i.e., highly desirable candidates.

In the embodiment illustrated in FIG. 2, the candidate has no relationship with company D 245. In an embodiment, the fact that company D is a member of the system is visible to the candidate and the system provides facilities to enable the candidate to follow or like company D. In an embodiment, the candidate cannot access company D's network page “www.tg.com/CompD” 245. In an embodiment, the candidate can access company D's network page “www.tg.com/CompD” 245, but does not receive updates from company D.

Note that, in some embodiments, one or more of the webpages shown in FIG. 2 could be provided via a third party site such as, for example, a social networking site such as for example, FACEBOOK and/or LINKEDIN and/or other available websites such as GOOGLE+. For example, a candidate could log into the system via FACEBOOK and interact with the system via forms hosted on FACEBOOK.

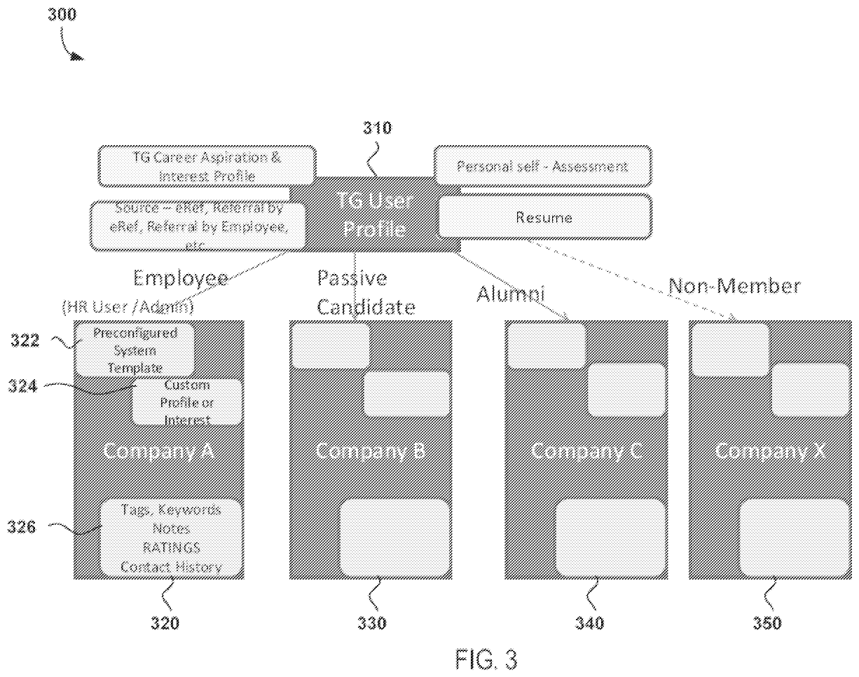

Referring now to FIG. 3 there is shown an illustrative view 300 of the types of user profiles 310 that are created and maintained by an embodiment of a system for recruiting candidates for employment opportunities.

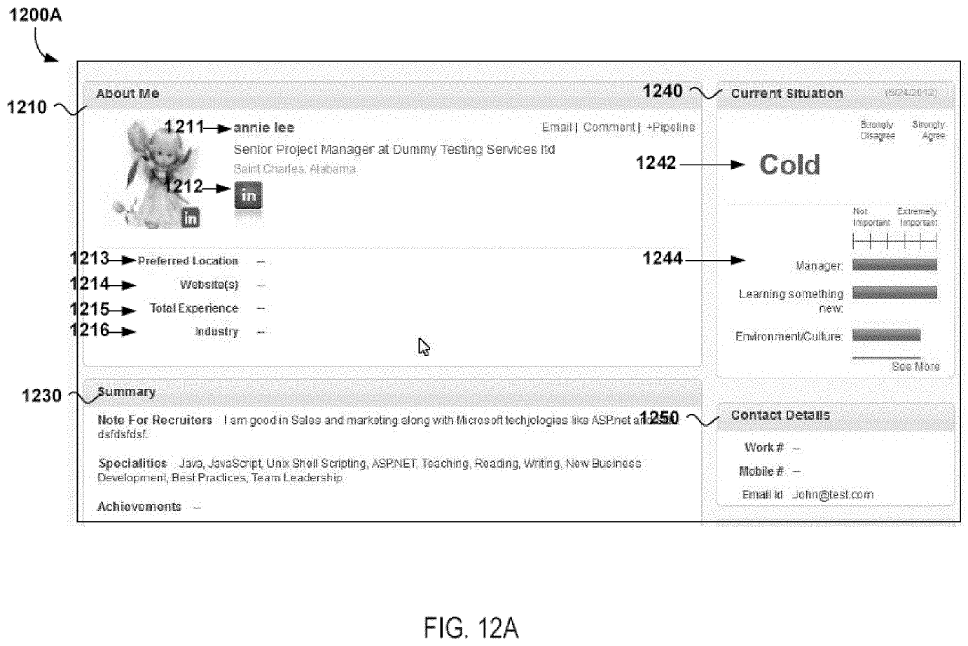

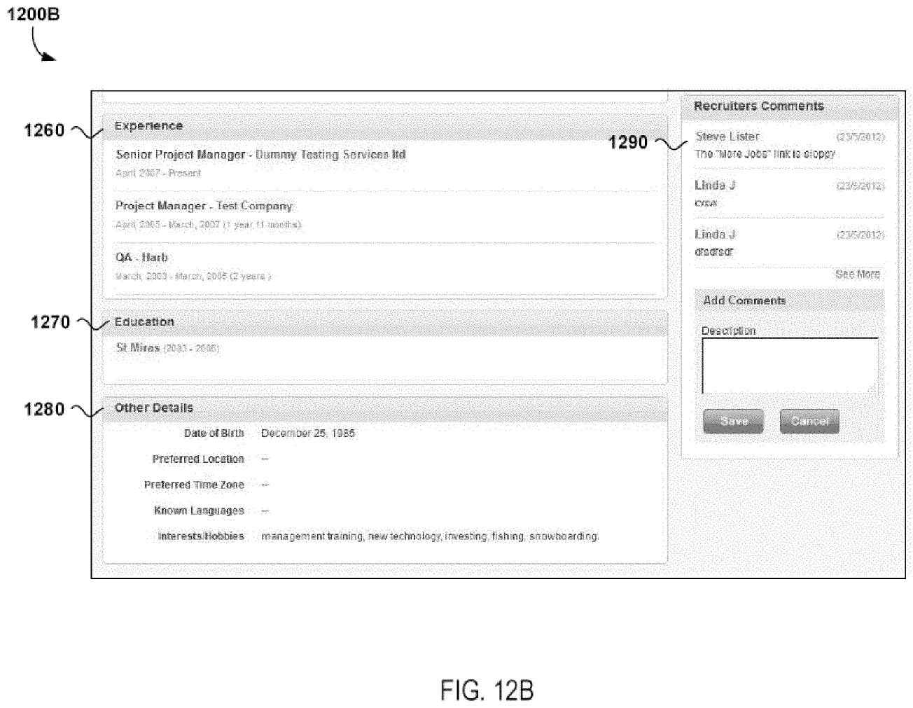

In an embodiment, when candidate or employer employees become members of the presently disclosed system, the system creates a user profile 310 for the member. In an embodiment, user profiles 310 are created by one or more talent relationship servers using data collected via, for example, user interfaces such as those shown in FIG. 7A, FIG. 7B, FIG. 8A, FIG. 8B, FIG. 8C, FIG. 11A, FIG. 11B, FIG. 12A, and FIG. 12B. In an embodiment, user profiles 310 are stored on one or more databases accessible to the talent relationship servers and can be updated on demand by members of the system.

In an embodiment, a profile 310 for an employee 320 (e.g., a recruiter) of an employer can include, for example, a “Preconfigured System” Template 322. In an embodiment, the Preconfigured System Template 322 is a set of questions that gathers information from candidates about a specific employer e.g., “What about Company makes you willing to consider working for Company”. In an embodiment, the profile 320 can additionally include the employee's interests 324. In an embodiment, the interests 324 are questions that the employer configures to ask candidates for further information that the employer would like to know. In an embodiment, the profile 320, the recruiter of the company will have tools to additionally add tags, keywords, notes, ratings and contact history on candidate information. Such information entered by one recruiter is visible to other recruiters.

In an embodiment, a profile 310 for a candidate 330 (passive, potential or active) can include, for example, the candidate's career aspirations and interest profile, the source that referred the candidate to the system and a personal self assessment. In further embodiments, the profile can include a copy of the candidate's resume or a link to such a resume. In an embodiment, the profile 320 can additionally include a Preconfigured System Template 324. In an embodiment, the profile 320 can additionally include tags, keywords, notes, ratings and contact history 326. In an embodiment, a profile 340 such as that described above can be provided in the case where the member is an alumni. In an embodiment, alumni is a role that a user could have as a member of the network. In an embodiment, alumni are friendly ex-employees. In an embodiment, the profile 340 can include, for example, the alumni's career aspirations and interest profile, the source that referred the alumni to the system and a personal self assessment. In an embodiment, the profile 340 can additionally include a Preconfigured System Template. In an embodiment, the profile 340 can additionally include tags, keywords, notes, ratings and contact history.

In an embodiment, a profile 350 such as that described above can be provided for a non-member. In an embodiment a non-member maintains a profile on the system but does not like, follow, or become a member of any employer networks.

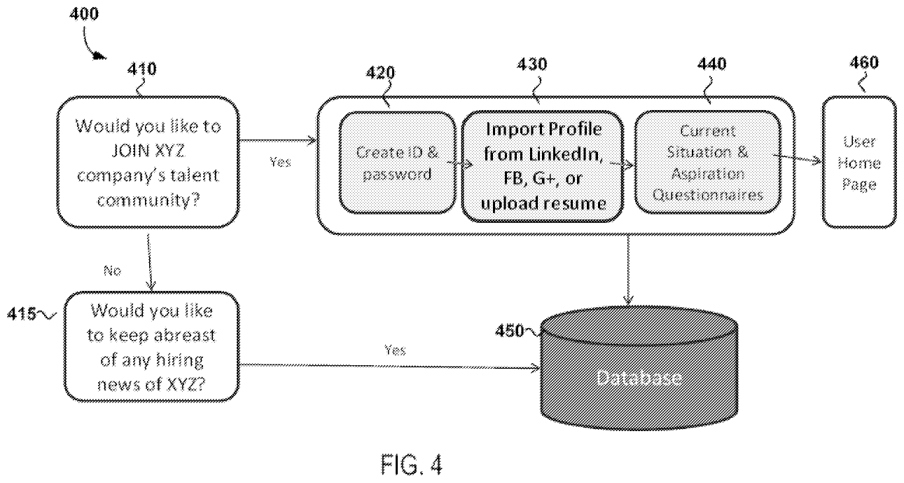

Referring now to FIG. 4, there is shown an embodiment of a process 400 to invite a candidate to become a member of a system for recruiting candidates for employment opportunities. In an embodiment, one or more servers such as the talent relationship servers 140 of FIG. 1 perform the operations of the method shown in FIG. 4, and databases 450 associated with the talent relationship servers store the data collected and stored by the method.

In block 410 of the method, a candidate is presented with an invitation to join an employer's network on the system (i.e., invitation is sent to candidate). It shall be understood that reference to a block in FIG. 4 also shall correspond to a step of a method. The invitation can be presented to the candidate via any suitable means for delivery of an electronic message, for example, via a webpage associated with the employer or a third-party service, an email or an SMS message.

In an embodiment, invitations can be directed to different sources of any type of candidate: passive, potential and active. The invitation can be customized to the specific primary psychographic profile of the pool candidates of each source. In an embodiment, the system can be used to preferentially attract passive candidates to become part of the employer's network by utilizing a source of candidates that tends to comprise a majority of persons that are not actively looking for work. Such sources of candidates could include sources that include reference checking, industry directories, industry publications, industry conference attendees and public documents such as patents and published patent applications.

Additionally or alternatively, in an embodiment, invitations can be sent to potential candidates by recruiters or other personnel within the employer's organization using facilities provided by the system. In an embodiment, recruiters send invitations to potential candidates in response to the potential candidate “liking” the employer within the system In an embodiment, recruiters send invitations to potential candidates identified using any suitable means such as, for example, without limitation, recommendations from other employees of the employer, listings in industry directories or publications, public records such as patent applications, and/or resumes or business cards collected at a job fair or industry event.

Additionally or alternatively, in an embodiment, invitations may be sent by current members (e.g., candidates) of the employer's network. For example, a current candidate may choose to invite a friend or associate.

In block 415 of the method, in an embodiment, if the candidate declines the invitation, the candidate will be asked if they would like to receive email updates of any hiring news from the employer. If they accept such an offer, the potential candidates will receive periodic emails with hiring news from the employer. Such emails can optionally, include new invitations to join the employer's network. In block 430 of the method, in an embodiment, if the candidate accepts the invitation, the user is directed to a page to log into the system if the candidate is already a member of the system (e.g., a member of another employer's network), or to register with the system (e.g., create ID and password). An illustrative embodiment of a user interface to log into the system or begin the registration process is shown in FIG. 7A and FIG. 7B (discussed below). In other embodiments, login or registration may be via facilities provided via a third-party website, for example, a social networking website such as FACEBOOK or LINKEDIN.

In an embodiment, in block 430 when a potential candidate initially registers with the system, the potential candidate is offered the opportunity to upload information such as a resume or import a profile from a third party website such as, for example, a social networking website such as FACEBOOK and/or LINKEDIN.

In block 440 of the method, in an embodiment, the candidate is then presented with a set of questions to determine the user's current situation, cultural preferences, temperature and aspirations. An illustrative embodiment of a user interface that enables a candidate to provide data that can be used to determine the candidate's situation, temperature and aspirations is shown in FIG. 8A, FIG. 8B and FIG. 8C (discussed below).

In an embodiment, when sufficient information has been gathered from the potential candidate using the data and/or information collected in this operation, a user profile is created for the candidate that reflects the connection to the employer and the user profile is stored on the system's databases 450. In an embodiment, when a potential candidate is already registered with the system, the candidate's user profile is updated on the system's databases 450 to reflect the new connection to the employer.

In block 460 of the method, in an embodiment, the candidate is then displayed a user home page where the candidate can, inter alia, view and update his or her profile data, provide additional profile data (e.g., job history, interests and preferences) and view employer connections. An embodiment of a user interface that enables a candidate to view and update the candidate's profile and employer connections is shown in FIGS. 9A-C (discussed below).

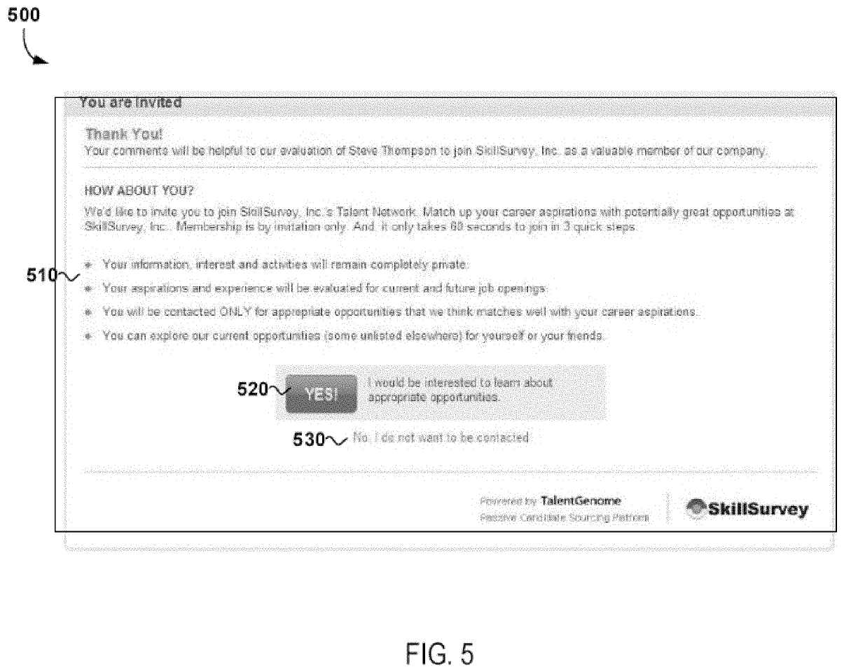

FIG. 5 illustrates an embodiment of an invitation 500 that can be sent to a candidate for them to become a member of an employer's network on a system for recruiting candidates for employment opportunities.

In various embodiments, the invitation 500 is provided as a webpage on a website. Such websites could include, for example, a reference checking system or other prehire information gathering system or an employer's website. In an embodiment, such a webpage-based invitation may be presented to a potential candidate while the potential candidate is interacting with a website, for example, after answering a survey that is part of a reference check, or alternatively, by clicking on a link in an email sent to the potential candidate by a recruiter or another candidate within an employer's network.

In the illustrated embodiment, the invitation 500 provides a brief explanation 510 of the purpose of the invitation 500. In response, the user or candidate can select the appropriate button: the “Yes” button 520 or the “No” button 530. The “Yes” button can indicate that the candidate is interested to hear or learn about the appropriate opportunities and the “No” button can indicate that the candidate does not have any interest and/or not want to be contacted further.

In various other embodiments, an invitation, rather than being provided as a webpage, could, for example, be provided as a link in an email or text message that, when selected, accepts the invitation and proceeds directly to login or registration. Alternatively, the HTML, code that implements the invitation 500 could be embedded in an email, allowing the potential candidate to display and interact with the invitation 500 without being linked to any website. Similarly, the candidate can take an appropriate action to accept or decline the invitation.

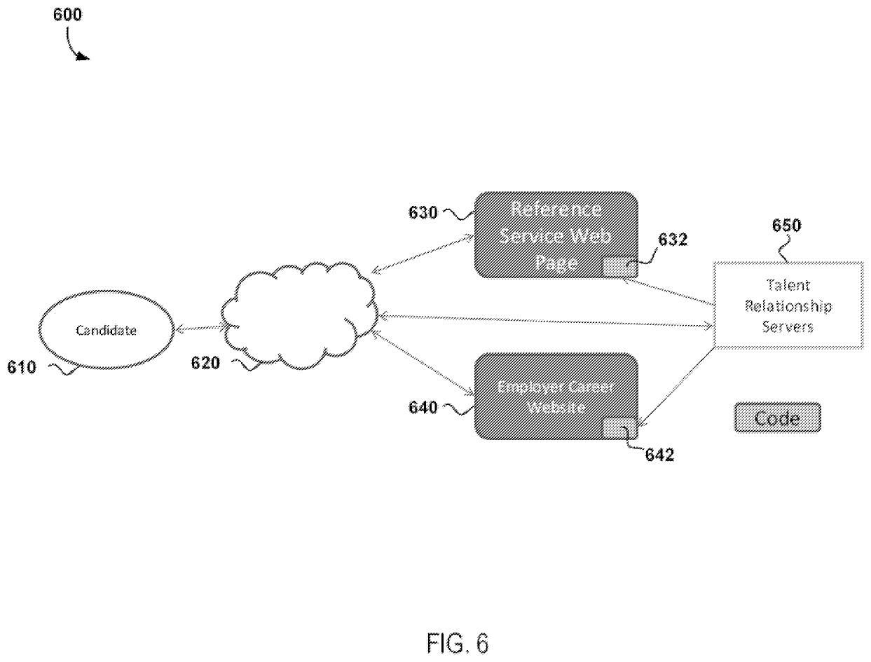

FIG. 6 shows an embodiment of a process 600 of how an invitation to become a member of a system for recruiting candidates for employment opportunities can be embedded in webpages that are potential sources of candidates.

In an embodiment, a candidate 610 accesses a webpage, over the Internet 620, that is, for example, a webpage 630 that is part of reference checking website or a webpage 640 that is part an employer's career website. The candidate may have reached the webpages 630 and 640 for a variety of reasons such as, for example, the candidate may have just completed a reference checking survey, or may have clicked on a link a recruiter emailed to the candidate.

Code that implements a client-side invitation process that links to talent relationship servers 650 is embedded 632 and 642 in each of the webpages 630 and 640. In an embodiment, all operations of candidate registration processes are performed by talent relationship servers 650 and the embedded code 632 and 642 is a script, for example, a JavaScript, that calls a webpage hosted by the talent relationship servers 650 and passes a few basic parameters to the servers to initially identify the candidate and the source of the candidate's referral, for example, the email address, last name and first name of the potential candidate 610 and a source code that identifies the referring system. In various other embodiments, the embedded code 632 and 642 could implement a heavier client process that renders user interface elements and gathers and processes data from the candidates in support of the registration process such as that illustrated in, for example, FIG. 4, as discussed in greater detail above.

In various other embodiments, the embedded code 632 and 642 can be embedded in a webpage in any website, such as a web page for a job-fair, a job board, a search result or any other website now known in the art or later to be developed. In yet other embodiments, the embedded code 632 and 642 can be embedded directly in an email or any other means, now known or later to be developed, for providing executable code to potential candidates.

FIG. 7A illustrates an embodiment of a user interface 700A that enables candidates to register with, a system for recruiting candidates for employment opportunities. In the illustrated embodiment, the user interface 700A provides means for new users to initiate registration with the system by entering a first name 710, a last name 712, an email address 714, a password 716, and password confirmation 718. After entering such information, the user/candidate would actuate or click the register button 719. Alternatively, a user can register with the system via any one or more social networking sites as is known in the art or sites hereinafter developed by selecting and clicking the appropriate button. For example, the user can click the button 720 for FACEBOOK or the button 730 for LINKEDIN.

FIG. 7B illustrates an embodiment of a user interface 700B that enables candidates who have previously registered as a user to login to a system for recruiting candidates for employment opportunities.

In the illustrated embodiment, the user interface 700 provides means for existing users of the system to log into the system by entering an email address 742 (which can be, in one embodiment, the user ID for the user within the system), a password 744 and clicking the login button 746. Alternatively, a user can log into the system via any one or more social networking sites as is known in the art or sites hereinafter by selecting and clicking the appropriate button. For example, the user can click the button 750 for FACEBOOK or the button 760 for LINKEDIN.

In an embodiment, the user interfaces 700A and 700B are implemented via a webpage that is hosted by one or more talent relationship servers.

FIG. 8A, FIG. 8B and FIG. 8C illustrate an embodiment of a user interface 800A, 800B and 800C that enables candidates to complete a short survey describing their current situation to a system for recruiting candidates for employment opportunities.

In the illustrated embodiment, the user interface 800 provides a questionnaire that asks four basic questions:
Is the candidate planning to look for a job in the near future 810 (FIG. 8A)?
How satisfied is the candidate satisfied with the candidate's current job or role 820 (FIG. 8A)?
What are the most important aspects of potential new employers 830 (FIG. 8B)? Benefits?
   Compensation? Career growth? Commute?
   Environment/culture?
   Job security?
   Learning opportunities? Location
   Manager
   Work-Life Balance
Is the candidate open to relocation 850 (FIG. 8C)?

In the illustrated embodiment, each of the questions 810, 820 and 830 (FIG. 8A, FIG. 8B) are answered by selecting ratio buttons that additionally indicate various degrees of agreement 810, satisfaction 820 and importance 830. In the illustrated embodiment, question 850 asks the candidate if they are open to relocation. In the illustrated embodiment, the interface 800 additionally provides a free form text entry box 840 for any other comments a candidate would like to direct to employers.

After completing the survey or questionnaire, the candidate actuates/clicks the submit button 860 to submit their reply. Alternatively, the candidate can terminate the process at any time before clicking the submit button by actuating/clicking the cancel button 870.

The questionnaire provided by the user interface 800A-C is purely illustrative, and not intended to be limiting. In various other embodiments, the questionnaire can include more or less questions and/or categories of questions. For example, in an embodiment, the questionnaire additionally includes questions implementing a self-assessment of the candidate's personality by the candidate. In an embodiment, the questionnaire can additionally or alternatively include questions implementing real-time situational testing. For example, a candidate interviewing for a customer service position could be presented with a prerecorded nasty customer phone call to which the candidate must respond. In another example, the questionnaire could provide, for a programmer, a coding problem to solve. In an embodiment, the questionnaire can additionally or alternatively include questions that assess cultural and behavioral responses to various situations. In other embodiments, candidates can be asked to rank or order various criteria which can be used to determine the ideal or preferred culture in which they would like to work. This cultural fit information can be used to assess the quality of the cultural match of the candidate to the culture of the companies or employers in the system.

In an embodiment, a candidate completes the questionnaire provided by the user interface 800A-C when first registering with the system. In an embodiment, a candidate completes the questionnaire provided by the user interface 800A-C whenever the candidate accepts an invitation from an employer to become a member of the employer's network. In an embodiment, a candidate completes the questionnaire whenever the candidate desires to update his or her profile, for example, in response to a change in the candidate's current job situation or attitude towards new employment opportunities.

In an embodiment, the user interface 800A-C is implemented via a webpage that is hosted by one or more talent relationship servers. In an embodiment, the user interface 800A-C is implemented via by a third-party website, such as any one or more social networking sites as is known in the art or sites hereinafter such as FACEBOOK or LINKEDIN. In an embodiment, the questions 810-850 are designed to be sufficiently informative such that when combined with, for example, a professional social networking profile (e.g., a LINKEDIN profile) the recruiter is equipped with the critical information so as to have a good ability to only contact the candidate when there is an open position that truly meets the aspirations and requirements of the passive candidate.

FIG. 9A, FIG. 9B and FIG. 9C illustrate an embodiment of a user interface 900A-C that provides a home page for a member (candidate) of a system for recruiting candidates for employment opportunities.

In an embodiment, the user interface 900A provides a summary section 910 (FIG. 9A) that can present basic information about the candidate, such as a picture, a current job title, education, a website or BLOG and the candidate's years in the field. In an embodiment, the summary can include links 912 to professional social networking profile for the candidate, such as for example the candidate's FACEBOOK and/or LINKEDIN profiles. In an embodiment, the user interface further provides sections displaying additional details about the candidate's work history 920 (FIG. 9A and FIG. 9B) and education 930 (FIG. 9C). Such details or information about work history 920 also can include more specific details and information about the candidate's work experience 922.

In an embodiment, the user interface 900 additionally provides a section summarizing the candidate's current situation 940. Such a section can include questions, inquiries or information requests (in whatever form) that can be used by a recruiter or employer to assess the candidate's desire of looking for a job as well as their suitability for a particular job and/or employer. In further embodiments, such questions, inquiries or information requests being provided are appropriate for the type of job and employer. In an embodiment, the section 940 includes a likelihood of looking for a job in the near future 942 and job satisfaction 943. In an embodiment, the section 940 additionally displays graphical representations of the candidate's most important factors in choosing a new job 944 such as, for example, commute 945, job security 946, career growth 947 and culture 948. In an embodiment, the section can be expanded 949 to show the importance of all factors the candidate will consider in choosing a new job.

In an embodiment, the user interface 900A, 900B additionally provides a section 950 that permits the candidate to import a profile for any one or more social networking sites as is known in the art or sites hereinafter such as profiles from LINKEDIN and FACEBOOK. In an embodiment, the user interface 900B provides a section 960 that prompts the candidate to add additional information to his or her profile. Note that, in an embodiment, a candidate can register with the system solely by providing a name, an email address and information relating to the candidate's current job situation. The more information, however, the candidate provides, the better employers can match the candidate to future opportunities.

In an embodiment, the user interface 900C additionally provides sections for miscellaneous personal information 970 other details 980 such as that detailed on FIG. 9C.

In various embodiments, once a candidate has supplied a sufficient amount of information to the system, the system can match the candidate to various open positions. In an embodiment, the system collects relevant demographic information on all job candidates. All such information can then be used by matching algorithms to match specific candidates with positions at a prospective employer. In an embodiment, using candidate profiles and assessments that the system has to perform, such as those described above, the system can generate a custom on-boarding plan on a per-candidate basis. In an embodiment, survey questions are statistically validated by existing behavioral research to predict factors related to turnover intentions.

In an embodiment, matching algorithms are subjected to established, stringent statistical analyses to ensure that there is no evidence of adverse impact. Such a feature serves to mitigate legal risk to the prospective employer, and results in fair treatment of all candidates. Job candidate selection is a type of “high stakes testing” and as such, must comply with both professional and federal guidelines.

Passive candidates differ in many ways, including their turnover intentions, their job fit and satisfaction, and thus their attractiveness to a potential employer. As such, in the Skill Survey database, all passive candidates who indicate that they want to learn more about career opportunities at a company are not equal. Some may not be as “attractive” as others (i.e., they may not be currently employed), and some may not be as motivated to leave their current positions are others.

Note that, in an embodiment, all or a portion of the candidate's profile is also visible to recruiters within employer networks of which the candidate is a member and employers the candidate has liked. See FIG. 12A and FIG. 12B, discussed below. In an embodiment, employers cannot update the candidate profile information displayed on this page.

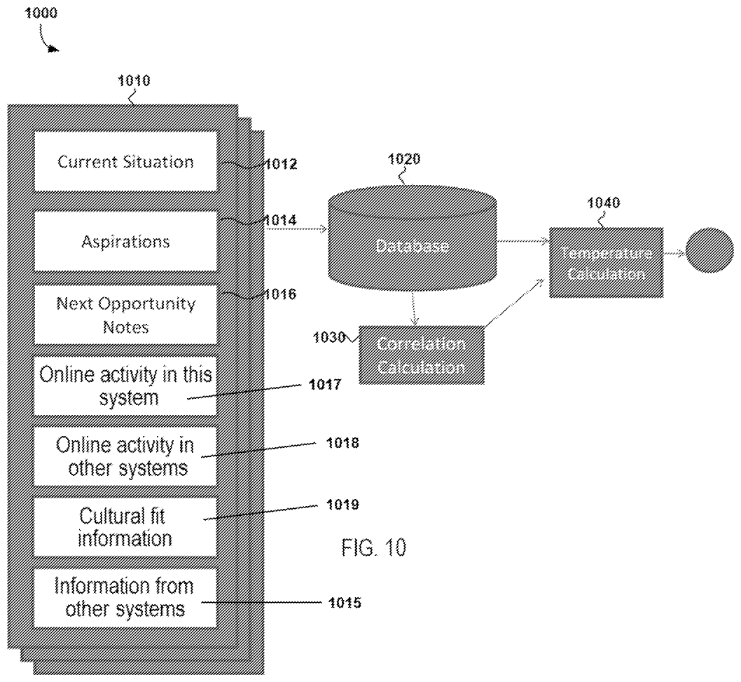

FIG. 10 shows an embodiment of a method or process 1000 to calculate a candidate's temperature (i.e., their inclination to consider a new opportunity). In an embodiment, one or more servers such as the talent relationship servers 140 of FIG. 1 perform the operations of the method shown in FIG. 5, and databases associated with the talent relationship servers store the data collected and stored by the method.

In block 1010 of the method, the system receives various types of candidate related information from a candidate. It shall be understood that reference to a block in FIG. 10 also shall correspond to a step of a method. In an embodiment, such information could include information related to the candidate's current situation 1012, aspirations 1014 and/or next opportunity notes 1016. Such information also can include specific online activities performed in this system (block 1017) such as updating their profile, online activities performed in other systems (block 1018) such as updating their professional social networking profile (e.g., their profile in LINKEDIN), cultural fit information (block 1019), and information gathered from other systems (block 1015). In an embodiment, the information relating to the current situation 1012, aspirations 1014 and/or next opportunity notes 1016 is collected using the user interface illustrated in FIG. 8A, FIG. 8B and FIG. 8C. The other information is collected using other user interfaces as are known to those skilled in the art or within the skill of those knowledgeable in the art to develop. In an embodiment, the candidate related information is stored on one or more databases 1020, for example, as part of a user profile for the candidate stored in a user profile database.

In block 1030 of the method, the system correlates the candidate's information with that of other candidates to yield one or more correlation metrics. For example, in an embodiment, the candidates answers to situation related questions can be correlated with the history of the way other candidates successfully hired by the employer have answered such questions. The inference is that a candidate that gives similar answers to past hires may be more likely to accept a new position with the employer if given the opportunity. Other correlation metrics could include, for example, various statistics relating to answers to situation related questions by all candidates, such a norm and/or variance for individual questions.

In block 1040 of the method, the system calculates the candidate's temperature. As noted above, in an embodiment, the candidate's temperature is an estimate of the likelihood the candidate is interested in considering new opportunities. In various embodiments, the candidate's temperature can be calculated using any combination of candidate data, employer data and/or correlation metrics that proves effective in identifying candidates that are eventually hired. Such combinations could be determined, for example, on a purely empirical basis based on historical data, or could be based on models designed by recruiters or other experts.

In an embodiment, the candidate's temperature is calculated to assess a candidate's inclination to consider a specific open position. For example, the temperature could be calculated using one or more of:
Correlation metrics for the candidate.
Candidate related information,
Job specifications for open positions.
Company cultural specified characteristics Engineering excellence
   Employee empowerment Constant innovation Risk aversion
   Constructive confrontation Quality
   Quality patient care and so forth

In an embodiment, the temperature of a candidate is determined using the answers to the following questions:
(1.) The candidate's level of agreement with the statement, “I'm planning to search for a new job within the near future”.
(2.) The candidates answer to the question “In General, how satisfied are you with your job or role”.
(3.) The candidate's indication of the level of importance of characteristics of the next opportunity the candidate would consider, for example:
   I. Benefits
   II. Compensation
   III. Career growth
   IV. Commute
   V. Environment/Culture
   VI. Job Security
   VII. Learning Something New VIII. Location
   IX. Manager
   X. Work-Life Balance
(4.) The candidate's indication if they are open to relocation.
(5.) The candidate's notes.

In an embodiment, a temperature calculation score is impacted by each answer to each question in the candidate's current situation. Online activity in the system (block 1017) can be assessed to increase the temperature score. Online activity in other systems (block 1018), such as updating a professional social networking profile (e.g., a Linkedin profile) can also be assessed to increase the temperature score. Information gathered from other systems (block 1015) also can be aggregated and be used in the temperature score. All of these factors are then weighted and combined into an overall score. The score is then categorized into Hot, Warm or Cold ranges that is displayed to recruiters.

In various other embodiments, the temperature of a candidate may be influenced by other factors. In an embodiment, the candidate's temperature may be adjusted relative to how well a job matches the candidate's aspirations. For example if a candidate indicates that that career growth is important, and the opening could be a promotion to their current job level, that would be a “hot” opportunity for the candidate. In various other embodiments, the temperature of a candidate may be influenced by any other data that tends to indicate the candidate is involved in activities that indicate the candidate may be looking for, or considering, other opportunities, for example, increased activity on the system's website and/or third party websites and/or increased travel. In an embodiment, the temperature of a candidate will decrease over time if additional actions are not taken by the candidate or some other user.

FIG. 11A and FIG. 11B illustrate an embodiment of a user interface 1100A, B that provides a dashboard for a recruiter using a system for recruiting candidates for employment opportunities.

In an embodiment, the user interface 1100A provides a candidate section 1110 that presents information for recently registered candidates and candidates matching open positions. Such information could include the candidate's profile picture 1112, a link to the candidate's professional social networking profile, (e.g., a LINKEDIN profile) 1114, the candidate's temperature 1116 and various links 1118 to means by which a recruiter can communicate with the candidate, for example, by email. In an embodiment, the candidate's section 1110 additionally includes a link 1119, that when selected, displays candidate's full profile, for example, using an interface similar to that shown in FIG. 12A and FIG. 12B (discussed below).

In an embodiment, the candidate's profile could include an icon or other feature reflecting a rating. In an embodiment, a rating is a value assigned to the candidate by a recruiter. In an embodiment, the candidate's rating reflects a recruiter's subjective assessment of a candidate's desirability. In an embodiment, the candidate's rating is added to a candidate's profile using a suitable user interface (e.g., icon, button) provided by the system. Alternatively or additionally, in an embodiment, the candidate's rating could be calculated, for example, using information from the candidate's profile and online behavior. For example, the system could analyze the demographics, online behaviors, resumes and so forth of a collection of hires of an employer and create a predictive model that could be applied to potential new candidates to assess the likelihood of such candidates having an interest in the employer.

In an embodiment, additionally or alternatively, candidates whose temperature and/or other profile data have changed recently, for example, in the last 24 hours, are displayed in the candidate section 1110. In an embodiment, only candidates having a threshold rating, for example, B or better, and whose temperature and/or other profile data has changed recently are displayed in the candidate section 1110. In an embodiment, only candidates having a threshold temperature, for example, “high” or better, and whose temperature and/or other profile data has changed recently are displayed in the candidate section 1110.

In an embodiment, the user interface 1100 additionally provides an active candidate section 1120 that displays the active candidates assigned to a recruiter. In various embodiments, candidates could be ranked by temperature, rating and/or the candidate's relative seniority or experience. The primary candidate section 1120 additionally includes a link 1122 that, when selected, displays a list of all candidates assigned to a recruiter.

In an embodiment, in general, the user interface 1100A only displays candidates assigned to a specific recruiter (e.g., the recruiter logged in and displaying the interface). In an embodiment, candidates are assigned to the recruiter that invited the candidate to join the employer's network. In an embodiment, candidates invited by current members, are assigned to the recruiter that is assigned to the inviting member. In an embodiment, candidates can be assigned or reassigned to various recruiters within a recruiting team by a supervisor. In an embodiment, candidates can be reassigned by a recruiter to another recruiter within a recruiting team. In an embodiment, a user interface is provided that lists all recruiters that have engaged a candidate and links to the history of their engagement.

In an embodiment, the user interface 1100B additionally provides team-related information to members of a recruiting team such as, for example, a team news section 1130. In an embodiment, the team news section 1130 provides a chronologically ordered list of posts by various members of the recruiting team. In an embodiment, the user interface 1100 additionally provides job-related information such as, for example, a list of open positions 1160.

In an embodiment, the user interface 1100B additionally provides a pipeline section 1140. In an embodiment, the user interface 1100 additionally provides means to invite users to become a member of the system 1170.

FIG. 12A and FIG. 12B illustrate an embodiment of a user interface 1200A, 1200B that allows a recruiter to view a profile of a member (candidate) of a system for recruiting candidates for employment opportunities.

In an embodiment, the user interface 1200A displays basic information 1210 about the candidate, including the name and current job title 1211, a link 1212 to the candidate's professional social networking profile (e.g., LINKEDIN profile), a preferred location 1213, websites 1214, total experience 1215 and industry 1216. In an embodiment, the user interface 1200A additionally displays a summary 1230 of the candidate's qualifications. In an embodiment, the user interface 1200A additionally displays a summary of the candidate's current situation 1240, including the candidate's temperature 1242 and important factors 1244 that the candidate is looking for in new employment opportunities. In an embodiment, the user interface 1200A additionally displays contact information 1250 for the candidate.

In an embodiment, the user interface 1200B additionally displays the candidate's job experience 1260 in detail. In an embodiment, the user interface 1200B additionally displays the candidate's education 1270 in detail and miscellaneous other personal information 1280 relating to the candidate. In an embodiment, the user interface 1200B additionally provides a recruiter comment section 1290 that provides means for recruiters to comment on a candidate.

FIG. 13 illustrates a process 1300 embodying various triggers 1310-1350 to prompt candidates to update their current situation with a system for recruiting candidates for employment opportunities.

In an embodiment, the system regularly prompts selected candidates to update their profile and/or their current situation on a regular basis, for example, by email 1360. In an embodiment, only candidates having a threshold rating, for example, 3 stars or better, are prompted to update their profile and/or their current situation to provide recruiter with the latest information about the candidate's situation.

In an embodiment, candidates are prompted to update their profile and/or their current situation in response to the occurrence of one or more triggers. In various embodiments, triggers can comprise any event that tends to suggest that a candidate's current situation may have changed, that the candidate's desirability to an employer has increased. In an embodiment, such triggers could include one or more of:
The candidate has not updated his or her situation for a threshold duration 1310.
Increased activity by the candidate on the system 1320 (e.g., looking at job postings).
The candidate's current employer is known to be in turmoil 1330.
The candidate's job profile matches a new position 1340.
The candidate has received an upward rating adjustment 1350.

In an embodiment, the threshold duration used by trigger 1310 can be based on the candidate's last answers to a situation questionnaire, for example, the system could determine the threshold duration based on the candidate's answer to the question “will you be looking for a job in near future?” For example:

| Will you be looking for a | |
|---|---|
| iob in near future? | Threshold Duration |
| Strongly Disagree | 12 months |
| Somewhat disagree | 9 months |
| neither | 6 months |
| Somewhat agree | 3 months |
| Strongly Agree | 1 month |

In an embodiment, determining a candidate's employer is in turmoil 1330 could be determined in a variety of ways. For example:
Based on news of layoffs, mergers, reorganizations, or bad financial reports.
Based on an increased number of applications from applicants working for the candidate's employer.

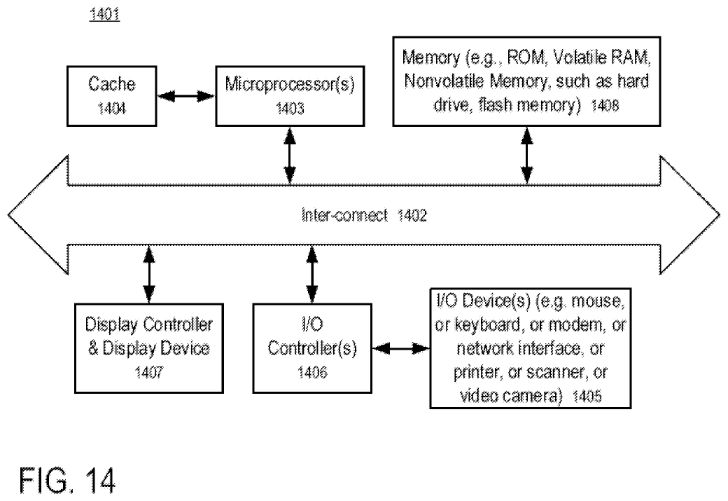

FIG. 14 shows a block diagram of an embodiment of a data processing system 1401 that can be used in various embodiments of the disclosed systems and methods. While FIG. 14 illustrates various components of a computer system, it is not intended to represent any particular architecture or manner of interconnecting the components. Other systems that have fewer or more components may also be used.

In FIG. 14, the system 1401 includes an inter-connect 1402 (e.g., bus and system core logic), which interconnects a microprocessor(s) 1403 and a memory 1408. The microprocessor 1403 is coupled to cache memory 1404 in the example of FIG. 14.

The inter-connect 1402 interconnects the microprocessor(s) 1403 and the memory 1408 together and also interconnects them to a display controller and display device 1407 and to peripheral devices such as input/output (I/O) devices 1405 through an input/output controller(s) 1406. Typical I/O devices include mice, keyboards, modems, network interfaces, printers, scanners, video cameras and other devices that are well known in the art.

The inter-connect 1402 may include one or more buses connected to one another through various bridges, controllers and/or adapters. In one embodiment the I/O controller 1406 includes a USB (Universal Serial Bus) adapter for controlling USB peripherals, and/or an IEEE-1394 bus adapter for controlling IEEE-1394 peripherals.

The memory 1408 may include ROM (Read Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory also can be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the talent relationship servers 140 of FIG. 1 and 650 of FIG. 6 are implemented using one or more data processing systems as illustrated in FIG. 14. In an embodiment, user devices used by candidates 110 and employees 120 to communicate with the talent relationship servers 140 of FIG. 1 are implemented using one or more data processing systems as illustrated in FIG. 14.

In some embodiments, one or more servers of the system illustrated in FIG. 14 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 1403 and/or the memory 1408. For example, the functionalities described above can be partially implemented via hardware logic in the microprocessor(s) 1403 and partially using the instructions stored in the memory 1408. Some embodiments are implemented using the microprocessor(s) 1403 without additional instructions stored in the memory 1408. Some embodiments are implemented using the instructions stored in the memory 1408 for execution by one or more general-purpose microprocessor(s) 1403. Thus, the presently disclosed embodiments are not limited to a specific configuration of hardware and/or software.

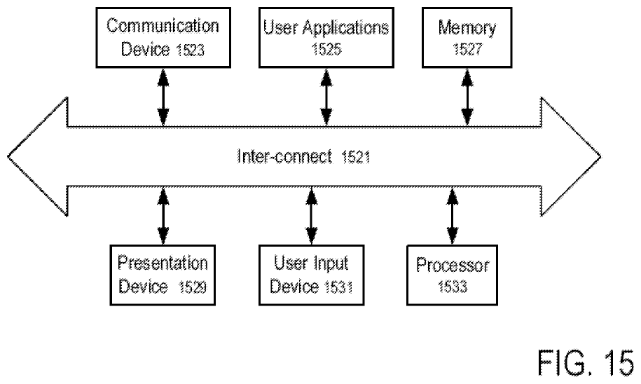

FIG. 15 shows a block diagram of an embodiment of a user device that can be used in various embodiments of the disclosed systems and methods. In FIG. 15, the user device includes an inter-connect 1521 connecting a communication device 1523, such as a network interface device, a presentation device 1529, such as a display screen, a user input device 1531, such as a keyboard or touch screen, user applications 1525 implemented as hardware, software, firmware or a combination of any of such media, such various user applications (e.g., apps), a memory 1527, such as RAM or magnetic storage, and a processor 1533 that, inter alia, executes the user applications 1525.

In some embodiments, the user applications implement one or more user interfaces displayed on the presentation device 1529 that provides users the capabilities to, for example, access the Internet, send and receive messages and/or receive and display offers transmitted by, for example, a mobile advertising service provider.

In some embodiments, users use the user input device 1531 to interacts with the device via the user applications 1525 supported by the device, for example, by accessing and interacting with websites, messages and offers described in detail above with respect to FIG. 1 and FIG. 2. The user input device 1531 may include a text input device, a still image camera, a video camera, and/or a sound recorder, etc.

In an embodiment, user devices used by candidates 110 and employees 120 to communicate with the talent relationship servers 140 of FIG. 1 are implemented using one or more user devices as illustrated in FIG. 15.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed herein can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium (i.e., a machine-readable medium) can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In an embodiment, there is provided a method for recruiting candidates for employment opportunities that is performed in a number of respects using a computer or computing device. Such a method includes providing to a candidate, an invitation to join an employer network of an employer and receiving from the candidate, an acceptance of the invitation. Such a method also includes, in response to receiving an acceptance of the invitation, requesting from the candidate, candidate related information. Such providing, receiving and requesting being done using a computing device.

Such a method also includes receiving from the candidate, the candidate related information and in response to receiving the candidate related information, determining using the candidate related information, a first temperature of the candidate. The first temperature of the candidate being a metric indicating the candidate's potential willingness to consider employment with the employer. In further embodiments, such a metric further indicates the cultural fit of the candidate to the employer. Such receiving and determining also being done using a computing device.

Such a method also includes receiving from the candidate, an update to the candidate related information and in response to receiving the update to the candidate related information, determining using the update to the candidate related information, a second temperature of the candidate. Also such a method includes determining that the second temperature is greater than the first temperature; and in response to determining that the second temperature is greater than the first temperature, notifying the employer that the second temperature is greater than the first temperature. Such receiving, determining and notifying being done using a computing device.

In a further embodiment, a machine readable media storing instructions that, when executed by a data processing system, cause the data processing system to perform a method, the method comprising: providing, to a candidate, an invitation to join an employer network of an employer; receiving, from the candidate, an acceptance of the invitation; in response to receiving an acceptance of the invitation, requesting, from the candidate, candidate related information; receiving, from the candidate, the candidate related information; in response to receiving the candidate related information, determining, using the candidate related information, a first temperature of the candidate, the first temperature of the candidate comprising a metric indicating the candidate's potential willingness to consider employment with the employer; receiving, from the candidate, an update to the candidate related information; in response to receiving the update to the candidate related information, determining, using the update to the candidate related information, a second temperature of the candidate; determining that the second temperature is greater than the first temperature; and in response to determining that the second temperature is greater than the first temperature, notifying the employer that the second temperature is greater than the first temperature. In yet further embodiments, such a first temperature metric further indicates the cultural fit of the candidate to the employer.

In a further embodiment, a computer system includes a memory; and at least one processor coupled to the memory to: provide, to a candidate, an invitation to join an employer network of an employer; receive, from the candidate, an acceptance of the invitation; in response to receiving an acceptance of the invitation, request, from the candidate, candidate related information; receiving, from the candidate, the candidate related information; in response to receiving the candidate related information, determining, using the candidate related information, a first temperature of the candidate, the first temperature of the candidate comprising a metric indicating the candidate's potential willingness to consider employment with the employer; receiving, from the candidate, an update to the candidate related information; in response to receiving the update to the candidate related information, determining, using the update to the candidate related information, a second temperature of the candidate; determining that the second temperature is greater than the first temperature; and in response to determining that the second temperature is greater than the first temperature, notifying the employer that the second temperature is greater than the first temperature. In yet further embodiments, such a first temperature metric further indicates the cultural fit of the candidate to the employer.

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations that are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A method comprising:
accessing, by at least one processor, at least one user profile database storing a plurality of active user profiles associated with a plurality of active users;
wherein the at least one user profile database comprises a schema configured to store the plurality of active user profiles in a standardized format according to a preconfigured system template;
wherein the plurality of active users actively engage with at least one entity-related network;
wherein at least one active user profile of the plurality of active user profiles specifies at least one other user to perform an action relative to the at least one active user profile;
determining, by the at least one processor, that the at least one other user is a new user based at least in part on the new user being different from each active user profile of the plurality of active user profiles in the at least one user profile database;
communicating, by the at least one processor, a questionnaire to the new user, wherein the questionnaire comprises a plurality of questions associated with a status of the new user;
receiving, by the at least one processor, at least one question response from at least one user selection performed by the new user in response to the plurality of questions of the questionnaire;
aggregating, by the at least one processor, inactive user data associated with the new user from the at least one question response and from across a plurality of public data sources across the internet associated with the new user;
determining, by the at least one processor, at least one activity metric indicative of a likelihood of the new user to perform an activity based at least in part on the inactive user profile data associated with the new user;
converting, by the at least one processor, the inactive user data associated with the new user into an inactive user profile for the new user, the inactive user profile conforming to the standardized format by populating the preconfigured system template based at least in part on the inactive user data;
storing, by the at least one processor, the new user profile in the at least one user profile database according to the schema;
periodically retrieving, by the at least one processor, from the plurality of public data sources across the internet, changes to the inactive user data;
dynamically determining, by the at least one processor, in response to the changes, at least one update to the at least one activity metric based at least in part on the changes to the inactive user data; and
automatically publishing, by the at least one processor to at least one electronic network page of the at least one entity-related network, at least one new user update to provide the new user profile and the at least one activity metric.

2. The method of claim 1, wherein the inactive profile of the new user comprises:
a plurality of answers to a questionnaire comprising a plurality of questions, wherein the plurality of questions comprise:
i) a question seeking a response to identify that the new user plans to seek a new job in the future,
ii) a question seeking a response to identify a satisfaction level of such new user with a current job of such new user,
iii) a question seeking a response to identify an importance ranking among job characteristics of a future job to be considered by such new user, and
iv) a question seeking a response to identify that such new user is open to relocation.

3. The method of claim 2, further comprising determining, using the at least one processor, the new user according to at least one trigger, wherein the at least one trigger is a lapse of a predetermined time interval determined based on the response to the question seeking a response to identify that the new user plans to seek a new job in the future.

4. The method of claim 3, wherein the at least one trigger is determined based on the new user data of the new user.

5. The method of claim 3, wherein the at least one activity metrics comprises a metric identifying a cultural fit of the new user to at least one particular entity associated with the entity-related network.

6. The method of claim 2, further comprising:
including, using the at least one processor, an electronic invitation to join the electronic entity network with an electronic request for providing at least one reference to an active user of the plurality of active users.

7. The method of claim 6, wherein inclusion of the electronic invitation is being controlled by the at least one entity.

8. The method of claim 1, further comprising causing to display, by the at least one processor, the at least one new user update to a graphical dashboard;
wherein the graphical dashboard further a custom on-boarding plan for the inactive user having a higher probability for applying to at least one specific user function.

9. The method of claim 1, wherein the inactive user profile of the new user comprises a rating which is calculated, based, at least in part, on the inactive user data.

10. The method of claim 9, further comprising determining, using the at least one processor, the new user according to at least one trigger, wherein the at least one trigger is determined based on the rating.

11. A system comprising:
at least one processor in communication with at least one non-transitory computer readable medium having software instructions stored thereon, wherein the at least one processor is configured, upon execution of the software instructions, to:
access at least one user profile database storing a plurality of active user profiles associated with a plurality of active users;
wherein the at least one user profile database comprises a schema configured to store the plurality of active user profiles in a standardized format according to a preconfigured system template;
wherein the plurality of active users actively engage with at least one entity-related network;
wherein at least one active user profile of the plurality of active user profiles specifies at least one other user to perform an action relative to the at least one active user profile;
determine that the at least one other user is a new user based at least in part on the new user being different from each active user profile of the plurality of active user profiles in the at least one user profile database;
communicate a questionnaire to the new user, wherein the questionnaire comprises a plurality of questions associated with a status of the new user;
receive at least one question response from at least one user selection performed by the new user in response to the plurality of questions of the questionnaire;
aggregate inactive user data associated with the new user from the at least one question response and from across a plurality of public data sources across the internet associated with the new user;
determine at least one activity metric indicative of a likelihood of the new user to perform an activity based at least in part on the inactive user profile data associated with the new user;
convert the inactive user data associated with the new user into an inactive user profile for the new user, the inactive user profile conforming to the standardized format by populating the preconfigured system template based at least in part on the inactive user data;
store the new user profile in the at least one user profile database according to the schema;
periodically retrieve from the plurality of public data sources across the internet, changes to the inactive user data;
dynamically determine in response to the changes, at least one update to the at least one activity metric based at least in part on the changes to the inactive user data; and
automatically publishing, by the at least one processor to at least one electronic network page of the at least one entity-related network, at least one new user update to provide the new user profile and the at least one activity metric.

12. The system of claim 11, wherein the inactive profile of the new user comprises:
a plurality of answers to a questionnaire comprising a plurality of questions, wherein the plurality of questions comprise:
i) a question seeking a response to identify that the new user plans to seek a new job in the future,
ii) a question seeking a response to identify a satisfaction level of such new user with a current job of such new user,
iii) a question seeking a response to identify an importance ranking among job characteristics of a future job to be considered by such new user, and
iv) a question seeking a response to identify that such new user is open to relocation.

13. The system of claim 12, wherein the at least one processor is further configured, upon execution of the software instructions, to determining, using the at least one processor, the new user according to at least one trigger, wherein the at least one trigger is a lapse of a predetermined time interval determined based on the response to the question seeking a response to identify that the new user plans to seek a new job in the future.

14. The system of claim 13, wherein the at least one trigger is determined based on the new user data of the new user.

15. The system of claim 13, wherein the at least one activity metrics comprises a metric identifying a cultural fit of the new user to at least one particular entity associated with the entity-related network.

16. The system of claim 12, wherein the at least one processor is further configured, upon execution of the software instructions, to:
including, using the at least one processor, an electronic invitation to join the electronic entity network with an electronic request for providing at least one reference to an active user of the plurality of active users.

17. The system of claim 16, wherein inclusion of the electronic invitation is being controlled by the at least one entity.

18. The system of claim 11, wherein the at least one processor is further configured, upon execution of the software instructions, to cause to display the at least one new user update to a graphical dashboard;
wherein the graphical dashboard further a custom on-boarding plan for the inactive user having a higher probability for applying to at least one specific user function.

19. The system of claim 11, wherein the inactive user profile of the new user comprises a rating which is calculated, based, at least in part, on the inactive user data.

20. The system of claim 19, wherein the at least one processor is further configured, upon execution of the software instructions, to determining, using the at least one processor, the new user according to at least one trigger, wherein the at least one trigger is determined based on the rating.
